(19) United States
(12) Patent Application Publication
(10) Pub. No.: US 2010/0094671 A1
(43) Pub. Date: Apr. 15, 2010

(54) PIN-less Debit Payment Processing

(75) Inventors: Robert L. Oaks, Swarthmore, PA (US); Peter M. Hamel, Liberty Lake, WA (US); James D. Richards, Santa Fe, NM (US)

Correspondence Address: SADLER, BREEN, MORASCH & COLBY, P.S., 422 W. RIVERSIDE AVE., SUITE 424, SPOKANE, WA, 99201, US

(73) Assignee: PE Systems, Spokane, WA (US)

(21) Appl. No.: 12/250,185

(22) Filed: Oct. 13, 2008

(51) Int. Cl. G06Q 40/00; G06Q 30/00; G06F 17/30

(52) U.S. Cl. 705/7; 705/35; 705/26

(57) ABSTRACT

This document describes tools for providing PIN-less debit (PLD) processing for a client, such as a merchant. In some embodiments, the tools intercept a request from a client to process a payment transaction for a consumer. If PLD processing is available for the transaction, the tools provide an indication to the client that PLD processing is an available option for processing the payment transaction. If the tools receive an indication that the consumer has opted to process the payment as a PLD transaction, the tools negotiate with a payment processor for fulfillment of the payment transaction. The tools are configured to handle one or more of the certification and compliance procedures required to process PLD transactions with a payment processor, thus allowing the client to process PLD transactions without having a direct payment processing relationship with a payment processor that offers PLD transaction processing.

### BACKGROUND

Today's consumer typically encounters a variety of different ways by which to purchase goods and services. For example, in online and ecommerce scenarios, a consumer may choose to pay using a credit card, an online payment transfer service (e.g., PayPal™), wire transfer, or many other payment options. While any one of these methods may suffice to facilitate a payment transaction, all of these methods have associated fees that increase processing costs for merchants. Some of these fees are calculated based on a percentage of the purchase amount, thus increasing the cost of the transaction in proportion to the price of the item(s) purchased. These costs and fees may be passed on to the consumer in the form of higher prices and/or through processing fees.

One payment method that avoids or reduces many of these processing fees is PIN-less debit (PLD) processing. PLD processing allows a consumer to process a payment using a debit card by providing the card number but without requiring the consumer to provide a personal identification number (PIN) for the transaction. PLD is particularly attractive for larger purchases because debit transactions impose a “flat fee” (e.g. $0.55) instead of a fee that is a percentage of the purchase price. Thus, for large transactions, using PLD significantly reduces the processing costs for merchants.

While PLD is desirable from a cost-reduction perspective, there is an implementation barrier that prevents many merchants from offering PLD as an available payment option. Part of this implementation barrier involves extensive changes to a merchant's internal processes that must be made to implement PLD. For example, a merchant's payment processing pipeline would need to be reconfigured to account for the addition of this payment processing option. In ecommerce scenarios, this can include changes to one or more payment-related pages of a merchant's website. Another part of the PLD implementation barrier is the certification and compliance requirements associated with offering PLD. To implement PLD, a merchant typically must undergo time-consuming certification procedures with one or more debit networks, payment gateways, and/or payment processors to ensure that the merchant can properly and securely transfer information to and receive information from the processors. Further, the merchant would be subject to compliance requirements that seek to verify that the merchant's internal processes are compliant with PLD requirements. Thus, despite the costs advantages associated with PLD payment processing, PLD has not been widely adopted.

### SUMMARY

This document describes tools for providing PIN-less debit (PLD) processing for a client, such as a merchant. In some embodiments, the tools intercept and/or interact with one or more aspects of a request from a client to process a payment transaction for a consumer. For example, when a card number is entered, the tools can determine based at least in part on the card number or other specified information if the payment transaction may be processed as a PLD transaction. If PLD processing is available for the transaction, the tools provide an indication to the client that PLD processing is an available option for processing the payment transaction. If the tools receive an indication that the consumer has opted to process the payment as a PLD transaction, the tools negotiate with a payment processor for fulfillment of the payment transaction. The tools are configured to handle the certification and compliance procedures required to process PLD transactions with a payment processor, thus allowing the client to process PLD transactions without having a direct payment processing relationship with a payment processor that offers PLD transaction processing.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTION OF THE DRAWINGS

Non-limiting and non-exhaustive embodiments are described with reference to the following figures, wherein like reference numerals may refer to like parts throughout the various views unless otherwise specified.

FIG. 1 illustrates an example operating environment in which various embodiments of the PIN-less debit (PLD) tools may operate.

FIG. 2 illustrates an example user interface that is configured to receive payment information from a consumer as part of payment processing requests.

FIG. 3 illustrates an example flow diagram of PIN-less debit payment processing using the PIN-less debit tools.

FIG. 4 illustrates an example flow diagram of one or more aspects of the PIN-less debit payment processing illustrated in FIG. 3.

FIG. 5 illustrates an example flow diagram of the PIN-less debit payment processing described in FIG. 4.

FIG. 6 illustrates an example flow diagram for building and utilizing a client profile for the PIN-less debit tools.

### DETAILED DESCRIPTION

Overview

The following discussion describes tools that provide PLD processing capabilities for a client. As discussed herein, a client may include any entity that offers goods and/or services in exchange for value, such as an online merchant or other entity. The tools may include a variety of platforms and/or methods that enable a client to easily implement PLD processing without the extensive implementation, certification, and compliance procedures typically required to process financial transactions via PLD. In some embodiments, the tools are configured to handle one or more of the certification and compliance procedures required to process PLD transactions with a payment processor, thus allowing the client to accept PLD consumer transactions independent of the client having a direct PLD processing relationship with a payment processor that offers PLD transaction processing. A direct PLD processing relationship can refer to a certified PLD transaction processing relationship with a payment processor, and/or a service provider relationship with a payment processor.

The tools may include a diverter service that receives a payment processing request from a consumer and determines if the consumer has indicated that the payment is to be processed as a PLD transaction. If the payment is to be processed as a PLD transaction, the diverter service forwards the payment processing request to one or more modules within a PLD gateway platform that then negotiate with one or more payment processors for the fulfillment of the payment processing request. If the consumer has requested that the payment be processed by a processing method other than PLD, the diverter service returns the payment processing request to the client for further processing in accordance with the other processing method.

The PLD gateway platform may include a field normalizer system (FNS) which converts client-specific data into an appropriate format so that a payment processing request can be properly processed by the PLD gateway platform. A specific instance of an FNS can be configured for a specific client and can thus account for a variety of data types and designations. Further aspects of the diverter service, the FNS, and the PLD gateway platform are discussed below.

An environment in which the PLD gateway platform tools may enable these and other actions is set forth below in a section entitled Example Operating Environment. This section is followed by Example User Interface, which describes one particular example in which a user may enter payment information for processing a payment transaction. A final section entitled Example Processes describes several processes that implement various aspects of the PLD gateway platform. This overview, including these section titles and summaries, is provided for the reader's convenience and is not intended to limit the scope of the claims or the entitled sections.

Example Operating Environment

Before describing the PLD gateway platform in detail, the following discussion of an example operating environment is provided to assist the reader in understanding some ways in which various aspects of the PLD gateway platform and aspects of the described tools may be employed. The environment described below constitutes but one example and is not intended to limit application of the tools to any one particular operating environment. Other environments may be used without departing from the spirit and scope of the claimed subject matter.

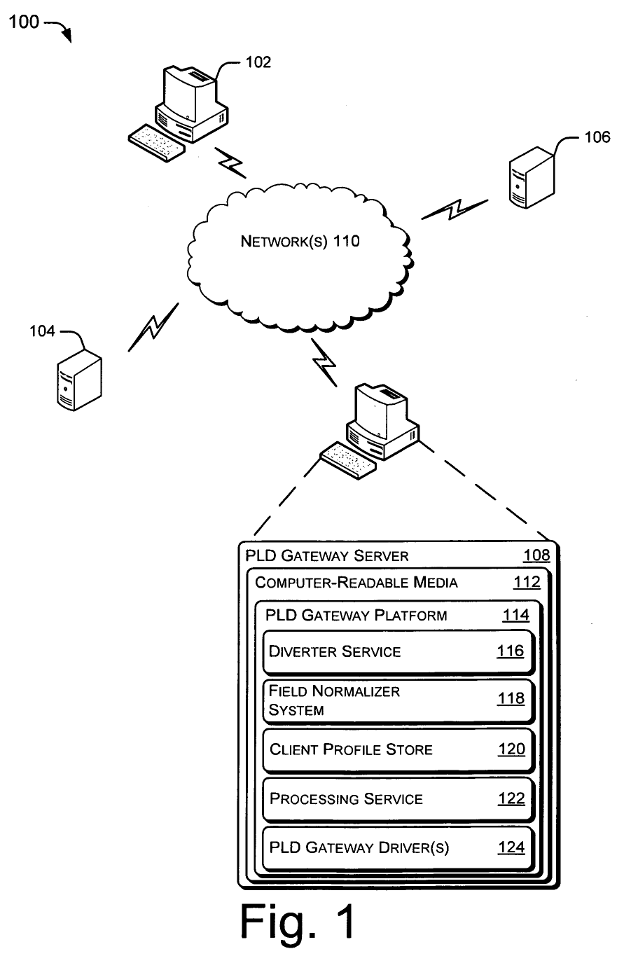

FIG. 1 illustrates generally at 100 one example of an operating environment in which various aspects of the tools may be employed. The operating environment 100 includes a consumer device 102, a client server 104, a payment processor 106, and a PLD gateway server 108. The various devices may communicate via one or more network(s) 110. While these devices are illustrated as specific types of devices, this is not intended to be limiting, and each of these devices may be embodied as any suitable computing device, such as a desktop computer, a laptop computer, a server tower or group of servers, a distributed computing resource, and so on. Each of the devices may include one or more processors and one or more computer-readable media.

The PLD gateway server includes one or more computer-readable media 112 and a PLD gateway platform 114 stored on the computer-readable media. The PLD gateway platform includes a variety of modules for implementing the various functionalities of the platform. These modules may include a diverter service 116, a field normalizer system 118, client profile store 120, a processing service 122, and one or more PLD gateway drivers 124. These modules are discussed in more detail below.

In one example embodiment, the client server may host a web page associated with a particular client or group of clients. A consumer may view the web page via a web browser running on the consumer's device and may purchase goods and/or services offered by the client(s) on the web page. If PLD processing is available for a particular purchase transaction and the consumer chooses to process the purchase transaction via PLD, the PLD gateway server negotiates with the payment processor(s) for fulfillment of purchase amount. The payment processor(s) may include an enterprise or other entity that negotiates with a debit network, a bank, or other financial institution for the fulfillment of a payment request. Examples of a payment processor include Chase Paymentech™, First Data Merchant Services™, and so on. When a payment processor has successfully negotiated the fulfillment of a payment request, funds are deposited into the client(s) bank account for the payment amount. In some embodiments, a client maintains a merchant account that is accessible to a payment processor to deposit funds received as part of a consumer transaction with the client.

If PLD processing is not available for the particular transaction and/or the consumer chooses not to process the transaction using PLD, the transaction may be rerouted to the client's server for further processing according to the client's payment processing procedures.

The following sections discuss in more detail specific aspects of the PLD gateway platform and how these aspects interact to perform various functions for the platform. Example embodiments of these aspects are discussed with reference to particular network communications protocols, such as the secure hypertext transfer protocol (HTTPs). This is not intended to be limiting, however, and one or more of a variety of other communication protocols may be utilized without departing from the spirit and scope of the claimed embodiments.

The Diverter Service

In one example embodiment, the diverter service is hosted by the PLD gateway server and performs a variety of tasks for the PLD gateway platform. Among these tasks are (1) diverting PLD transactions to the processing service for further processing and (2) causing non-PLD transactions to be transparently processed according to a client's specific payment processing procedures. The diverter service may be accessed by POSTing payment data (e.g., a payment card number, a payment amount, and so on) to a specific URL associated with the diverter service. POSTing refers generally to an HTTPs method that submits data from one or more resources (e.g., a merchant's web page) to one or more other resources for processing. The POST data may also include a client identifier (ID) that identifies a particular client to the diverter service. The diverter service utilizes transparent data encapsulation techniques such that, when payment information as part of a purchase transaction is returned to the client server in non-PLD scenarios, the client server does not detect that the payment information has been diverted and inspected by the diverter service. This transparency may be accomplished by transferring the unaltered original POST data to the client for further processing. In some embodiments, the client identifier is removed from the POST data before the data is routed to the client.

Implementing the diverter service for a particular client does not require changes to be made to the form fields of the client's web page. The client ID is added automatically to the POST data without requiring the client server associated with the client to add a form field for the ID. When the form is submitted, the FORM tag's ACTION attribute is dynamically altered to reference the PLD gateway server URL. Thus, when a consumer submits payment data for a purchase, the POST data is automatically forwarded to the diverter service at the PLD gateway server. By requiring minimal changes to a client's web page, the PLD gateway platform may be integrated into a client's payment process virtually seamlessly and with little resource cost to the client.

While the diverter service is discussed as performing a variety of tasks as part of processing payment information, in some embodiments, one or more of the actions of the diverter service may be performed at the client within the client software, such as deciding whether to process a transaction according to default client-specific transaction processing procedures (e.g., as a credit transaction), or to process the transaction as a PLD transaction through the PLD gateway.

In embodiments where payment processing decisions occur on the client side, transaction information may be reported to the PLD gateway for tracking, analysis, and other purposes. For example, if a consumer chooses not to process a payment using PLD processing and this decision is processed on the client side, this decision and/or other transaction information may be reported to the PLD gateway. The reporting may occur concurrently with and/or subsequent to the payment transaction processing. The PLD gateway can track transaction processing information to identify trends and/or other phenomena in payment processing decisions, thus allowing the PLD gateway to accommodate client and/or consumer preferences. Thus, the PLD gateway can be aware of payment processing decisions and/or information, even if the gateway does not process the decision and/or information.

The Field Normalizer System

As discussed above, the POST data submitted to the diverter service as part of a payment fulfillment request from a client web page is typically not altered from its original form as determined by the client's specific form data labels and designators. To aid the PLD gateway platform in interpreting the client-specific data, the field normalizer system (FNS) provides a mechanism for mapping the client-specific form data to a set of generic field names that are specific to and recognized by the PLD gateway platform and can be used to process a payment transaction. The FNS may also perform translation and/or transformation of data as part of payment information processing. For example, a transaction amount may be entered using one type of currency (e.g., the euro) and the FNS can translate the transaction amount into another type of currency (e.g., the dollar) to meet the particular data processing needs of the PLD tools and/or of a client. A particular instance of an FNS is configured for a specific client and the configuration information is stored in a client profile. Client profiles are described in more detail below.

Each client profile may be uniquely identified by a client ID or other information that identifies a particular client and/or processing characteristics. In some embodiments, the PLD gateway platform includes a script library that is referenced by a client's web page and that causes a client ID to be automatically added to POST data that is sent to the diverter service as part of a payment processing request. The script library may access a client ID from a plurality of client IDs stored by the PLD gateway platform. The diverter service uses the client ID to access the client profile for the specific client.

As one example implementation of the FNS, consider a client web page that includes a variety of fields that may be populated with data. A first field is labeled by the client as “AcctNo” and is used to by the client's web page to receive an account number for a particular consumer as part of a purchase transaction. The PLD gateway platform, however, recognizes the field name “AN” as corresponding to the account number data. Thus, the PLD gateway platform may not recognize the “AcctNo” field name in its raw form as submitted in the POST data. To address this scenario, the client profile for this client includes a form field mapping that maps the client-specific “AcctNo” field to the PLD gateway platform-specific “AN” field, thus enabling the PLD gateway platform to properly receive the account number data from the client for further processing. This field mapping is given as an example only, and a particular client profile may include a number of different field mappings.

In some embodiments, form fields and/or other data (e.g., a PLD gateway-specific client identifier) may be stripped from payment processing information before the information is forwarded to other locations and/or entities (e.g., a payment processor).

Client Profiles

The PLD gateway platform may include a client profile store that maintains client profiles for a plurality of clients. As discussed above, each client profile includes a client ID and mappings from client-specific form field designators to PLD gateway platform-specific form field designators. Within a particular client profile there may be two general types of mapping entries: Input mapping entries and output mapping entries. Each of these mapping entries is discussed below.

The input mapping entries include method parameter entries and pass-through entries. Method parameter entries relate client-specific form fields to input parameters that are utilized by specific PLD gateway platform methods. For example, the PLD gateway platform includes a method that is responsible for invoking the appropriate driver(s) for processing a PLD transaction, referred to herein as the ProcessPLDTransaction method. One example of an input mapping entry handles card expiration date data and maps a client's “ExpDate” form field to the ProcessPLDTransaction's “ExpirationDate” parameter. Thus, when the ProcessPLDTransaction method is called by the PLD gateway platform, the diverter service knows to copy the value of the client's “ExpDate” field to the method's “ExpirationDate” parameter.

Pass-through input mapping entries do not typically map to PLD gateway platform method parameters, but are made available for pass-through purposes. In one example, a particular client may want to provide a specific payment confirmation message that notifies a consumer of the status of the consumer's payment processing (e.g., “Bob, your payment has been successfully received”). To accomplish this, a pass-through input mapping entry is created in the client profile. A pass-through mapping entry indicates that data with a particular label is to be passed through without conversion/translation processing. For example, the payment confirmation message may be labeled “ConfirmMsg”, and a pass-through entry is created that indicates that the “ConfirmMsg” data is to be passed through the PLD gateway platform without alteration and/or processing.

The output mapping entries include method return entries and pass-through output mapping entries. Method return entries map PLD gateway platform method return values to client-specific values expected by one or more web pages associated with a client. For example, specific method return mapping entries may map PLD gateway platform method return values to the output HTTP GET and/or POST variables expected by a client's “Confirm Payment” page and “Complete Payment” page. GET refers to an HTTP method that retrieves specifically-requested information (e.g., via a Request-URI) from a resource. Example entries may relate the ProcessPLDTransaction method return values: “Decision”, “ReceiptNumber”, and “AuthorizationCode”, to the client-specific POST variables: “DecisionCode”, “ReceiptNum”, and “AuthCode”, respectively.

Pass-through output mapping entries relate input map entries directly to client-specific output variables (e.g., output GET/POST variables). For example, one pass-through output mapping entry may relate the input map's “CustomerName” field to a “CustomerName” POST variable. This allows a client to provide customized messages that will not be altered by the PLD gateway platform during payment transaction processing. As shown in the example above, a client may provide a customized payment confirmation message that includes a particular consumer's name.

As discussed above, some embodiments of the FNS can perform translation and/or transformation of data as part of payment data processing. In these embodiments, a client profile may include translation and/or transformation values. In the example of currency exchange given above, the translation and/or transformation values would include an exchange rate from one form of currency to another.

A client profile may also include one or more client-specific URLs that identify particular web pages and/or resources associated with a particular client. Examples of client-specific URLs are a OriginalProcessPayment URL, a CompletePayment URL, and a ConfirmPayment URL. The OriginalProcessPayment URL represents a client's “Process Payment” page, which may be called by the diverter service if a particular payment transaction is not to be processed as a PLD transaction. As discussed above, in non-PLD processing scenarios, the original POST data received from a client is returned from the diverter service to the client (e.g., to the OriginalProcessPayment URL).

The CompletePayment URL represents the URL of a client's “Complete Payment” page. The Complete Payment page provides back-end processing for client's payment processing transactions. The PLD gateway server will POST transaction return information to the CompletePayment URL. In some embodiments, the client and/or the PLD gateway server may host a PLD CompletePayment web page that enables a client to record PLD transactions separately from the client's own CompletePayment page. The PLD CompletePayment page can enable a client to do back-end processing of PLD transaction data separately from and/or in conjunction with the client's standard CompletePayment page(s).

Note that many websites perform an HTTP REDIRECT instead of a POST to some sort of confirmation page once a payment transaction has been processed. REDIRECT is a method that provides, among other things, a new destination address based on a previously-specified address. One problem with this approach is that REDIRECT is an intrinsically unreliable mechanism because it depends on the consumer's browser, which may be unavailable (e.g., due to network issues, security settings, and so on). This unreliability is relatively inconsequential for confirmation pages that simply notify the consumer that the transaction was completed. For confirmation pages that perform back-end processing (e.g., recording the fact that a parent has paid a child's tuition bill), this unreliability may be unacceptable. Therefore, some websites, before redirecting to the confirmation page, post the return information (e.g., data returned from a processor API call such as authorization code, request ID, reason code, and so on) to a separate CompletePayment URL that performs the back-end processing. POST is typically a more reliable mechanism because it does not depend on a consumer's web browser.

The ConfirmPayment URL represents a web page that acknowledges that a consumer's payment transaction has been completed. In one example, after return information is POSTed to the CompletePayment URL, the diverter service redirects to the ConfirmPayment URL, which provides some type of payment processing acknowledgement to the consumer. A REDIRECT is sufficient for this purpose, because no back-end processing occurs in this context.

Example User Interface

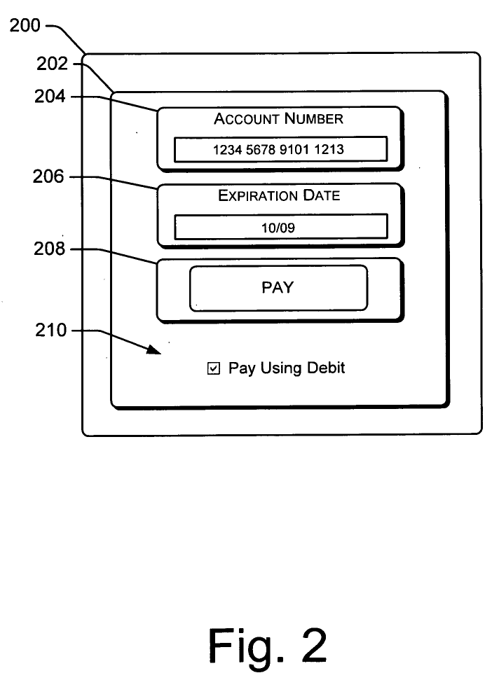

FIG. 2 illustrates an example user interface 200 that can implement one or more aspects of the PLD gateway platform. The user interface may be hosted by the client server 104, discussed above, and may be associated with a particular client or group of clients that offer a variety of goods and/or services for purchase by a consumer.

Displayed within the user interface is a payment information form 202 that provides several fields for entering payment information. For example, the payment information form includes an account number field 204 that enables a consumer to provide the consumer's account number, and an expiration date field 206 that enables the consumer to provide an expiration date of the particular payment card (e.g., a debit card, a credit card, and so on) associated with the account number provided. Also displayed is a pay button 208 that, when activated, submits the provided payment information for processing.

Displayed at 210 is a debit option field (e.g., a “Pay Using Debit” checkbox) that allows a consumer to select PLD processing, when available, for a particular transaction. In scenarios where PLD is not available for a particular transaction (e.g., where the account number provided is for a credit card that does not have PLD capability), the debit option field may be disabled or hidden such that it cannot be selected by the consumer. In scenarios where PLD is available for processing a particular transaction, the debit option field may be automatically selected such that the transaction will be automatically processed as a PLD transaction unless the consumer explicitly unchecks the debit option field (e.g., it is a default processing option). Alternatively, when PLD is available for a particular transaction, the debit option field may not be selected by default but may be selectable by the consumer to indicate that the consumer wishes to process the transaction as a PLD transaction.

Although not expressly illustrated here, the payment information form may display one or more logos for payment processing networks and/or services that are supported by the client and/or the PLD gateway platform.

The payment information form may be hosted by the client server or, alternatively, may be hosted by the PLD gateway server. For example, the payment information form may be inserted by the PLD gateway server into the client's web page. In these scenarios, the payment information form is displayed inside of an IFRAME and the payment information form code resides on the PLD gateway server.

Example Processes

The following section discusses several example processes that implement various functionalities of the PLD gateway platform. One or more aspects of the example processes may be implemented in software, hardware, firmware, or a combination thereof. One or more of the specific blocks within each process may represent a particular set of computer-executable instructions that implements the functionality described within the respective block.

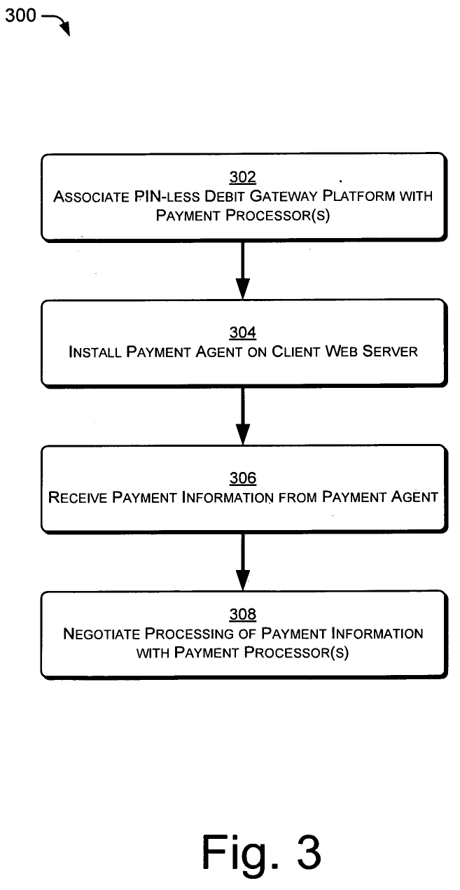

FIG. 3 illustrates at 300 a general process that implements various functionalities of the PLD gateway platform. Block 302 associates the PLD gateway platform with one or more payment processors. Associating the PLD gateway platform with a particular payment processor includes implementing one or more certification and/or compliance procedures required to process PLD payments using the payment processor. Thus, in one sense the PLD gateway platform provides “proxy certification and compliance” for a client that utilizes the PLD gateway platform to process payments. The client need not be certified with a particular payment processor or undergo compliance procedures to process a PLD transaction. The client simply submits payment information to the PLD gateway platform and various tools within the platform negotiate with a payment processor for the fulfillment of the payment request. Even though a client may not require certification to process PLD transactions, the client may nonetheless be certified to process other types of transactions, such as credit transactions.

Block 304 installs a payment agent on a client device of a client that chooses to utilize the PLD gateway platform to process PLD transactions. The payment agent may include an application, script, or other functionality that communicates information between the client and the PLD gateway platform. When a client enters payment information as part of a purchase transaction, the payment agent captures the payment information and forwards the information to the PLD gateway platform for further processing. Block 306 receives payment information at the PLD gateway platform from the payment agent that resides on a particular client. Payment information may include an account number, an expiration date for a payment card, a purchase amount, and so on. Block 308 negotiates with a payment processor for the fulfillment of a payment request based at least in part on the payment information provided.

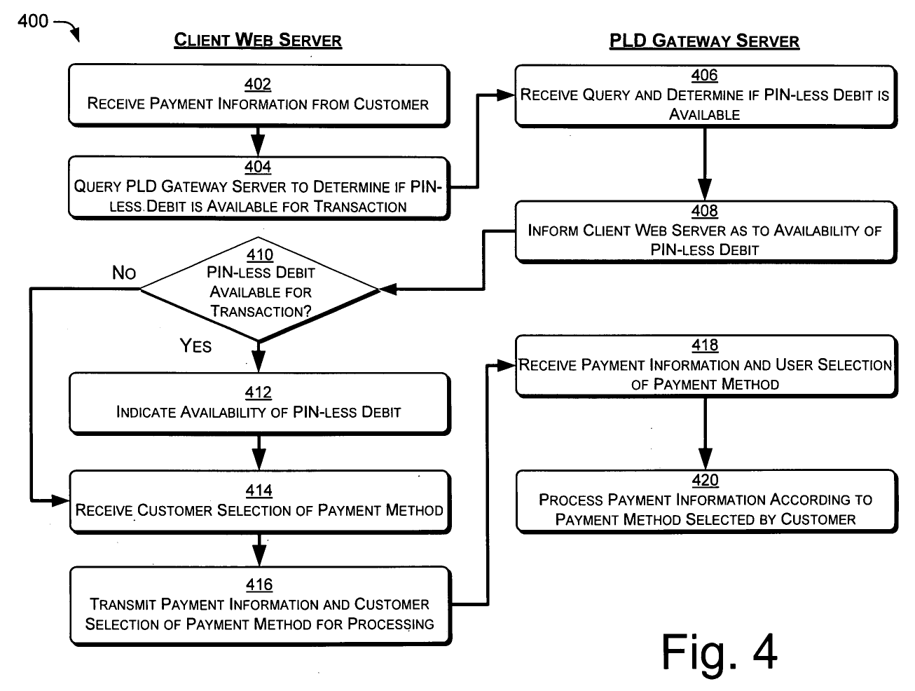

FIG. 4 illustrates at 400 one example of a more detailed process for implementing various aspects of the PLD gateway platform. As illustrated, certain acts occur at a client web server and others occur at the PLD gateway server. This is not intended to be limiting, however, and other example embodiments may implement individual acts and functionalities of the PLD gateway platform at alternate locations.

Block 402 receives payment information from a consumer as part of a purchase transaction. Block 404 queries the PLD gateway server to determine if PLD processing is available for this particular transaction. The query may comprise transmitting one or more pieces of the payment information to the PLD gateway server (e.g., a consumer account number). The PLD gateway server may query the payment processor to determine if PLD processing is available for a particular transaction. In some embodiments, the PLD gateway server may store data locally that enables the client to determine, without calling the payment processor, if PLD processing is available for a particular transaction. For example, the PLD gateway server may store bank identification numbers (BINs) that enable the PLD gateway server to determine if PLD processing is available based on a particular BIN received as part of a transaction. In these embodiments, the PLD gateway server does not need to query the payment processor to determine if PLD processing is available for a particular transaction.

In some embodiments, other information may be considered to determine if PLD processing is available and/or appropriate for a particular transaction. For example, a transaction amount floor limit may be imposed for PLD transactions. If a particular transaction amount falls below the floor limit, the PLD gateway may prevent PLD from being available (e.g., by deactivating and/or removing the “Pay Using Debit” checkbox). Imposing a floor limit for PLD transactions may prevent a client from incurring excessive processing fees for transactions where a percentage-of-transaction charge would be less than the flat fee charged for a debit transaction. Other factors may also be considered in determining if PLD processing is available, such as the risk involved in the transaction, the processing requirements associated with the particular payment card, and so on.

Block 406 receives the query at the PLD gateway server and determines if PLD processing is available for the purchase transaction (e.g., based on an account number). In one example, this determination is made by calling an API function that is part of the processing service 122. For purposes of this example, the API function is referred to as “IsPLDAvailable”. The API may be called as soon as a consumer has provided a card number without having to wait for the payment information to be expressly submitted by the consumer (e.g., by pressing the “pay” button on payment information form 202). In one embodiment, the payment agent installed on the client web server hooks an OnBlur event for the account number field and calls IsPLDAvailable (e.g., using Asynchronous JavaScript and XML, or “AJAX”) as soon as a complete account/card number is provided and prior to the user expressly submitting the payment information.

In embodiments where the diverter decision occurs on the client side, the payment agent installed on the client web server may hook an OnChange event for the “Pay Using Debit” checkbox, which causes the form action to call the PLD gateway instead of the client's standard payment processing page.

The IsPLDAvailable API then calls one or more PLD gateway drivers that communicate with an appropriate payment processor or local criterion, such as Bank Identification Number (BIN) range data, to determine if PLD processing is available based on the payment information. Each driver is specifically configured to communicate with one or more payment processors and, in some embodiments, each payment processor has an associated PLD gateway driver that is maintained by the PLD gateway platform. By implementing a PLD gateway driver layer as part of the PLD gateway platform, the complexity of negotiating with individual payment processors and/or payment networks is handled by the driver(s) and hidden from the client and/or other PLD gateway platform services. Thus, if clients are added, transaction volume changes, and/or payment processors are added or deleted, PLD gateway drivers can be reconfigured or added without requiring changes to the client and/or other PLD gateway platform services.

Returning to the discussion of process 400, block 408 informs the client web server as to the availability of PLD processing for the particular transaction. Block 410 receives the information from the PLD gateway server and determines, based on the information, if PLD processing is available for the transaction. If PLD processing is available (“Yes”), block 412 indicates the availability to the consumer. As discussed above, this indication may include activating a debit selection option on the client's web page. The indication may also include displaying one or more debit network logos on the client's web page that indicate one or more debit networks supported by the PLD gateway platform. As also discussed above, if PLD is available for a transaction, the PLD processing option may be selected by default and may be deselected by express action by the consumer. In some implementations, when a consumer chooses to process a payment using PLD processing (e.g., by checking the PLD checkbox), the card expiration date field is disabled on the web form. Block 414 receives the consumer's selection of a payment method. If PLD processing is not available (“No”), block 414 receives the consumer's selection of a payment method without indicating the availability of PLD processing.

Block 416 transmits the consumer's payment information and the consumer's selection of a payment method to the PLD gateway server for processing, and block 418 receives the payment information and the selected payment method at the PLD gateway server. Block 420 processes the payment information according to the method selected by the consumer.

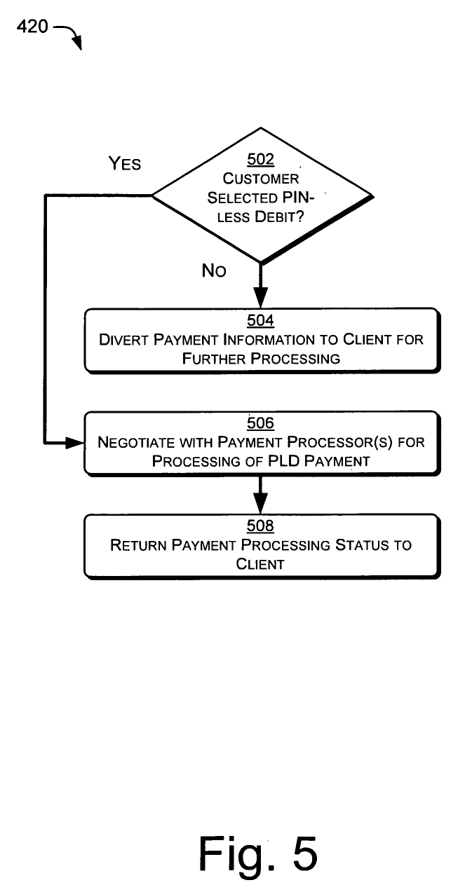

FIG. 5 illustrates a flow diagram of example aspects of block 420, discussed above. Block 502 determines if the consumer has selected PLD processing for the particular transaction. In some embodiments, this decision occurs at the diverter service that resides on the PLD gateway platform. If the consumer has not selected PLD processing (“No”), at block 504 the diverter service diverts one or more pieces of the payment information back to the client's for further processing. For example, the diverter service may divert payment information to a payment processing web page maintained by the client web server.

If the consumer has selected PLD processing (“Yes”), block 506 negotiates with one or more payment processors for fulfillment of the PLD payment request. In one example, if the consumer has selected PLD processing, the diverter service diverts the payment information to the processing service for further processing. The payment processor may use the consumer's account number to retrieve consumer funds and forward the funds to the client. As discussed above, the processing service may include a ProcessPLDTransaction API that, when called, invokes one or more PLD gateway drivers to negotiate for payment fulfillment with a payment processor and/or debit network. Block 508 returns payment processing status information to the client. For example, if the PLD transaction was successfully completed with a payment processor, the client would be so notified and the client could display a payment confirmation message to the consumer via the client's payment confirmation page. Alternatively, if the PLD transaction was not successful, the client could display a payment processing failure message to the consumer.

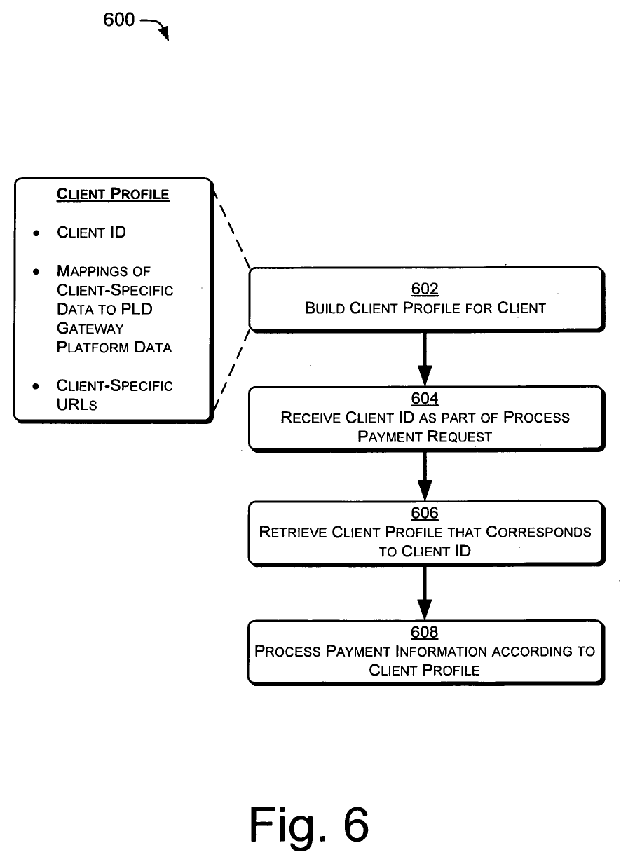

FIG. 6 illustrates a flow diagram of a process 600 for generating and implementing a client profile for a particular client. Block 602 builds a client profile for a particular client. As illustrated, the client profile includes a client ID that identifies the client to the PLD gateway platform, mappings of client-specific data (e.g., field names) to PLD gateway platform data, and one or more client-specific URLs. These aspects of the client profile are discussed in more detail above. Block 604 receives the client ID as part of a request by the client to process payment information. Block 606 retrieves the client profile that corresponds to the client ID. Block 608 processes the payment information based at least in part on the information included in the client profile.

As explained in the discussion above, the PLD gateway platform provides a quick and transparent way for a client to offer and implement PLD processing. The platform allows the client to configure its web page to accept PLD transactions without requiring the client to be certified with a payment processor to accept PLD processing requests. In some embodiments, the PLD gateway platform enables a client to process purchases using PLD without the client having a direct PLD processing relationship with a payment processor. In other words, the client submits PLD payment information to the PLD gateway platform and the platform negotiates PLD transactions for the client. Thus, the client is able to offer PLD processing to consumers and receive value for PLD transactions via the PLD gateway platform. In some examples, all a client is required to do is install an application on its web server (e.g., the payment agent discussed above) that communicates payment information between the client and the PLD gateway platform. The PLD gateway platform handles all negotiation with the payment processors and/or debit networks, and thus the client need not be certified with a payment processor that handles PLD transactions and need not necessarily undergo the often onerous compliance procedures required to handle PLD transactions. In some embodiments, a client may be Payment Card Industry (PCI) compliant but may not have a direct PLD processing relationship with a payment processor. Thus, the client may use the PLD gateway platform to process PLD transactions without having and/or independent of a direct payment processing relationship with a payment processor.

Various techniques may be described herein in the general context of software or program modules and the techniques may utilize a variety of communication protocols and/or messaging formats. Generally, software includes routines, computer-executable instructions, programs, objects, components, data structures, and so forth that perform particular tasks or implement particular abstract data types. An implementation of these modules and techniques may be stored on or transmitted across some form of computer-readable media. Computer-readable media can be any available medium or media that can be accessed by a computing device. By way of example, and not limitation, computer readable media may comprise “computer storage media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Conclusion

The above-described tools provide PIN-less debit processing for a client. Although the tools have been described in language specific to structural features and/or methodological acts, it is to be understood that the tools defined in the appended claims are not necessarily limited to the specific features or acts described. Rather, the specific features and acts are disclosed as example forms and/or implementations of the tools.

1. One or more computer-readable media storing computer-executable instructions, the computer-executable instructions being configured to implement a method comprising:
receiving payment information from a client;
determining that the payment information comprises a request to process the payment information as a PIN-less debit transaction; and
causing at least part of the payment information to be processed by a payment processor as a PIN-less debit transaction independent of a direct PIN-less debit processing relationship between the client and the payment processor.

2. A method as recited in claim 1, wherein the payment information is received from a web page hosted by the client.

3. A method as recited in claim 1, wherein the payment information is received from the client as part of a consumer purchase from the client.

4. A method as recited in claim 1, wherein the payment information comprises an account number for a consumer of the client, the account number being used by the payment processor to retrieve consumer funds.

5. A method as recited in claim 1, further comprising, responsive to the act of receiving the payment information from the client, determining if the payment information may be processed as a PIN-less debit transaction.

6. A method as recited in claim 5, wherein the act of determining if the payment information may be processed as a PIN-less debit transaction comprises determining if a transaction amount associated with the payment information falls below a floor limit.

7. A method as recited in claim 5, wherein the act of determining if the payment information may be processed as a PIN-less debit transaction comprises calling an API that queries the payment processor with a consumer account number to determine if PIN-less debit processing is available for the consumer account number.

8. A method as recited in claim 1, further comprising providing payment processing status information to the client that informs the client that the payment was successfully processed or that the payment was not successfully processed.

9. A method comprising:
receiving a request to process payment information for a client;
determining if the request comprises one or more of (1) a request to process the payment information as a credit transaction or (2) a request to process the payment information as a PIN-less debit transaction; and
responsive to determining that the request comprises a request to process the payment information as a credit transaction, routing the payment information to be processed according to client-specific credit processing procedures; or
responsive to determining that the request comprises a request to process the payment information as a PIN-less debit transaction, causing at least part of the payment information to be processed by a payment processor independent of a direct payment processing relationship between the client and the payment processor.

10. A method as recited in claim 9, wherein the payment information is received as part of a consumer transaction with the client.

11. A method as recited in claim 9, wherein the request comprises a client profile, the client profile comprising a client ID and one or more client-specific URLs, one or more of the client-specific URLs specifying a client web page for retrieving or posting data associated with the request.

12. One or more computer-readable storage media storing one or more computer-executable modules, the modules comprising:
a diverter tool configured to receive payment information from a client and to determine if the payment information comprises one or more of (1) a request to process the payment information as a credit transaction or (2) a request to process the payment information as a PIN-less debit transaction; and
a driver module configured to, responsive to a determination that the payment information comprises a request to process the payment information as a PIN-less debit transaction, receive the payment information from the diverter tool and forward at least part of the payment information to a payment processor to be processed as a PIN-less debit transaction, the processing of the payment information by the payment processor occurring independent of a direct PIN-less debit processing relationship between the client and the payment processor.

13. One or more computer-readable storage media as recited in claim 12, wherein the diverter tool is further configured to identify the client based at least in part on a client ID received as part of the payment information.

14. One or more computer-readable storage media as recited in claim 12, wherein the driver module comprises a plurality of drivers, one or more of the plurality of drivers being configured to negotiate for the fulfillment of a PIN-less debit transaction with the payment processor.

15. One or more computer-readable storage media as recited in claim 12, wherein the modules further comprise a field normalizer that maps client-specific data designators to data designators that are recognized by the diverter tool.

16. One or more computer-readable storage media storing one or more computer-executable modules, the modules comprising:
a processing tool configured to determine, based at least in part on payment information received from a client, if the payment information may be processed as a PIN-less debit transaction and, responsive to a determination that the payment information may be processed as a PIN-less debit transaction, provide an indication to the client that the payment information may be processed as a PIN-less debit transaction; and
a diverter tool separate from and associated with a payment processor, the PIN-less debit tool being configured to: receive the payment information from the client; determine if the payment information comprises a request to process the payment information as a PIN-less debit transaction; and, responsive to a determination that the payment information comprises a request to process the payment information as a PIN-less debit transaction, forward at least part of the payment information to the payment processor for processing as a PIN-less debit transaction.

17. One or more computer-readable storage media as recited in claim 16, wherein the payment information comprises an account number, and wherein the processing tool determines if the payment information may be processed as a PIN-less debit transaction by calling an API that queries the payment processor to determine if PIN-less debit processing is available for the account number.

18. One or more computer-readable storage media as recited in claim 16, wherein the modules further comprise a client profile store storing a plurality of client profiles, each of the client profiles comprising:
a client identifier;
one or more client-specific URLs;
parameter mapping entries that map client-specific data designators to designators for data that is processed by one or more of the processing tool or the diverter tool; and
pass-through mapping entries that specify client-specific data that is to be passed through one or more of the processing tool or the diverter tool without being processed.

19. One or more computer-readable storage media as recited in claim 18, wherein the modules further comprise a field normalizer that accesses one or more of the client profiles and performs parameter mapping as part of the processing of the payment information.

20. A method implemented at least in part by a computing device, the method comprising:
receiving payment information from a client;
determining, based at least in part on the payment information, if the payment information may be processed as a PIN-less debit transaction;
responsive to determining that the payment information may be processed as a PIN-less debit transaction, providing an indication to the client that the payment information may be processed as a PIN-less debit transaction;
receiving a request from the client to process the payment information as a PIN-less debit transaction; and
causing at least part of the payment information to be processed as a PIN-less debit transaction by a payment processor independent of a direct payment processing relationship between the client and the payment processor.

21. A method as recited in claim 20, wherein the payment information comprises a client identifier and an account number for a consumer transaction with the client.

22. A method as recited in claim 20, wherein the determining if the payment information may be processed as a PIN-less debit transaction comprises querying the payment processor with the account number to determine if PIN-less debit processing is available.

23. A method as recited in claim 20, wherein the determining if the payment information may be processed as a PIN-less debit transaction comprises determining if a transaction amount associated with the payment information falls below a floor limit for PIN-less debit transactions.

24. A method as recited in claim 20, further comprising returning payment processing status information to the client that specifies either that the payment information was successfully processed or that an error occurred in processing the payment information.

25. A method implemented at least in part by a computing device, the method comprising:
providing, at a first user interface hosted by a client, a second user interface hosted by a PLD gateway server, the PLD gateway server being distinct from the client, and the second user interface being configured to receive payment information for the client;
receiving, at the PLD gateway server, payment information entered into the second user interface;
determining that the payment information comprises a request to process the payment information as a PIN-less debit transaction;
forwarding at least part of the payment information from the PLD gateway server to a payment processor to be processed as a PIN-less debit transaction; and
receiving an indication that the payment information was successfully processed.

26. A method as recited in claim 25, wherein the second user interface indicates that PIN-less debit processing is a default payment information processing method.

27. One or more computer-readable storage media storing computer-executable instructions, the computer-executable instructions being executable to:
provide a user interface hosted at a PIN-less debit platform to a web site hosted at a client, the user interface being configured to enable entry of payment information for a transaction with the client, the PIN-less debit platform being distinct from the client;
receiving at the PIN-less debit platform payment information provided via the user interface;
determining if the payment information comprises a request to process the payment information as a credit transaction or a request to process the payment information as a PIN-less debit transaction; and
responsive to a determination that the payment information comprises a request to process the payment information as a credit transaction, routing the payment information to the client; or
responsive to a determination that the payment information comprises a request to process the payment information as a PIN-less debit transaction, routing at least part of the payment information to a payment processor to be processed as a PIN-less debit transaction.

28. One or more computer-readable storage media as recited in claim 27, wherein the payment information comprises an account number, and wherein the computer-executable instructions are further executable to, responsive to receiving the payment information at the PIN-less debit platform, determine if PIN-less debit processing is available for the account number.

29. One or more computer-readable storage media as recited in claim 27, wherein the computer-executable instructions are further executable to, responsive to receiving the payment information at the PIN-less debit platform, determine if PIN-less debit processing is available to process the payment information based at least in part on comparing a transaction amount associated with the payment information with a floor limit transaction amount for PIN-less debit processing.
